(19) United States
(12) Patent Application Publication
(10) Pub. No.: US 2011/0075443 A1
(43) Pub. Date: Mar. 31, 2011

(54) LIGHT EMITTING UNIT, BACKLIGHT MODULE AND DISPLAY DEVICE

(75) Inventors: Ying Che HUANG, Changhua County (TW); Dong Xian YU, Nantou County (TW)

(73) Assignee: HANNSTAR DISPLAY CORP., Taipei County (TW)

(21) Appl. No.: 12/855,818

(22) Filed: Aug. 13, 2010

(30) Foreign Application Priority Data
Sep. 28, 2009 (TW) 098132675

(51) Int. Cl. F21V 7/22; F21S 4/00

(52) U.S. Cl. 362/606; 362/249.01; 362/249.02; 362/613; 362/612

(57) ABSTRACT

A light emitting unit includes a light bar set, a connecting mechanism and a closed-loop terminal. The light bar set includes a plurality of light bars, wherein each light bar includes a plurality of light emitting elements and a circuit board, and the light emitting elements are disposed on the circuit board. The connecting mechanism includes a plurality of connecting elements for electrically connecting the first one to the last one of the light bars in order. The connecting mechanism has a front end and a rear end. The closed-loop terminal is electrically connected to the rear end of the connecting mechanism, whereby the light bar set, the connecting mechanism and the closed-loop terminal are formed to a closed loop.

### CROSS REFERENCE TO RELATED APPLICATION

This application claims the priority benefit of Taiwan Patent Application Serial Number 098132675, filed on Sep. 28, 2009, the full disclosure of which is incorporated herein by reference.

### TECHNICAL FIELD

The invention is related to a light emitting unit, and more particularly to a light emitting unit of a backlight module of a display device, wherein the light emitting unit is assembled only by enough normalized light bars in number and a closed-loop terminal.

### BACKGROUND

Referring to FIG. 1, it depicts a light emitting diode (LED) type light bar 10 having a single integral body. The LED type light bar 10 can be a light emitting unit of a backlight module of a liquid crystal display device. A plurality of light emitting diodes (LEDs) 12 are mounted on a printed circuit board 16 by a surface mounting technology (SMT) process. A connector 18 is mounted at one end of the printed circuit board 16. One end of a flexible circuit board 14 is electrically connected with the connector 18, and the other end of the flexible circuit board is electrically connected with another printed circuit board (not shown) of a liquid crystal display panel of the liquid crystal display device, whereby electrical power is transmitted to energize the LED type light bar 10.

However, according to the LED type light bar of the backlight module of the large-size liquid crystal display device, the LED type light bar having the single integral body must be long, and thus the printed circuit board of the LED type light bar is also long. If the printed circuit board is longer, the yield of the printed circuit board is lower and manufacture cost of the printed circuit board is higher accordingly.

Furthermore, according to the LED type light bar (having the single integral body) of the backlight module of the large-size liquid crystal display device, the number of the LEDs of the LED type light bar must be more, and thus the failure probability of the LED type light bar is higher. If the LED type light bar having the single integral body is failed, the whole light bar must be replaced so as to have higher maintenance cost.

Accordingly, there exists a need for a light emitting unit capable of solving the above-mentioned problems.

### SUMMARY

The present invention provides a light emitting unit including a light bar set, a connecting mechanism and a closed-loop terminal. The light bar set includes a plurality of light bars, wherein each light bar includes a plurality of light emitting elements and a circuit board, and the light emitting elements are disposed on the circuit board. The connecting mechanism includes a plurality of connecting elements for electrically connecting the first one to the last one of the light bars in order. The connecting mechanism has a front end and a rear end. The closed-loop terminal is electrically connected to the rear end of the connecting mechanism, whereby the light bar set, the connecting mechanism and the closed-loop terminal are formed to a closed loop.

According to the light emitting unit of the backlight module of the large-size liquid crystal display device, the present invention provide a light emitting unit which is assembled with enough normalized light bars in number in accordance with design requirement, and thus the light emitting unit of the present invention has no problem of a longer circuit board of the conventional light emitting unit (having the single integral body). Furthermore, the number of the LEDs of the single normalized light bar of the present invention is not more, but enough LEDs in number are shared by a plurality of normalized light bars. Therefore, if a normalized light bar is failed, only the failed normalized light bar is replaced rather than the whole light emitting unit is replaced so as to save material cost. In addition, normalized light bars of the light emitting unit of the present invention are easily manufactured and stocked so as to have lower product cost.

The foregoing, as well as additional objects, features and advantages of the invention will be more apparent from the following detailed description, which proceeds with reference to the accompanying drawings.

### BRIEF DESCRIPTION OF THE DRAWINGS

Embodiments of the present invention are illustrated by way of example, and not by limitation, in the figures of the accompanying drawings, wherein elements having the same reference numeral designations represent like elements throughout and wherein:

FIG. 1 is a cross-sectional schematic view of a LED type light bar in the prior art;

FIG. 2 is a perspective schematic view of a light emitting unit according to the first embodiment of the present invention;

FIGS. 3a and 3b are plan schematic view of a light emitting unit according to an example of the first embodiment of the present invention, showing a normalized light bar before assembly and a light emitting unit after assembly;

FIGS. 4a and 4b are plan schematic view of a light emitting unit according to an alternative example of the first embodiment of the present invention, showing a normalized light bar before assembly and a light emitting unit after assembly;

FIGS. 5a and 5b are plan schematic view of a light emitting unit according to another example of the first embodiment of the present invention, showing a normalized light bar before assembly and a light emitting unit after assembly;

FIGS. 6a and 6b are plan schematic view of a light emitting unit according to another alternative example of the first embodiment of the present invention, showing a normalized light bar before assembly and a light emitting unit after assembly;

FIG. 7 is an exploded perspective schematic view of a side light type backlight module according to the first embodiment of the present invention;

FIG. 8 is a partially cross-sectional schematic view of a side light type backlight module according to the first embodiment of the present invention;

FIG. 9 is an exploded perspective schematic view of a display device according to the first embodiment of the present invention;

FIG. 10 is a perspective schematic view of a light emitting unit according to the second embodiment of the present invention; and

FIG. 11 is a cross-sectional schematic view of a direct light type backlight module according to the second embodiment of the present invention.

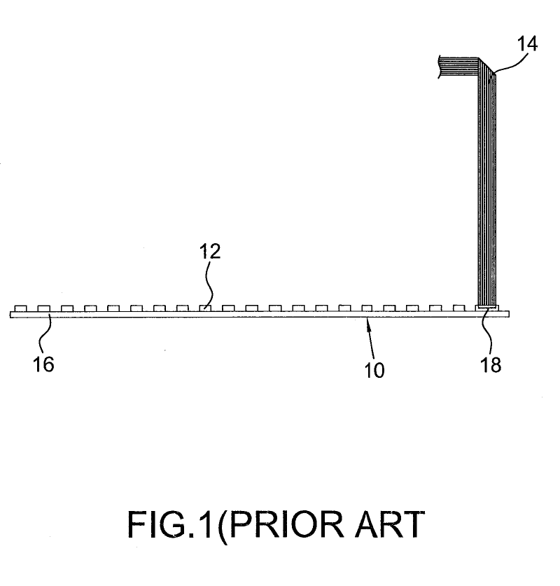

### DETAILED DESCRIPTION OF THE PREFERRED EMBODIMENT

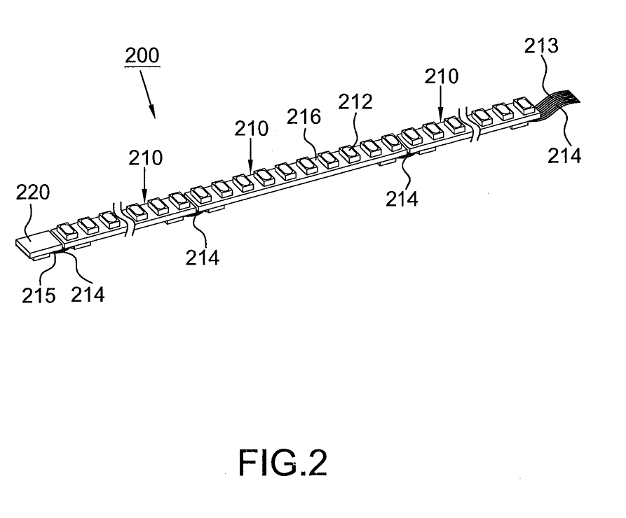

Referring to FIG. 2, it depicts a light emitting unit 200 according to the first embodiment of the present invention. The light emitting unit 200 includes a light bar set, a connecting mechanism and a closed-loop terminal 220. The light bar set includes a plurality of normalized light bars 210. The light bars 210 are arranged in the one-dimensional direction. Each light bar 210 includes a plurality of light emitting elements 212 and a circuit board 216 (e.g. printed circuit board), and the light emitting elements 212 are disposed on the circuit board 216. The light emitting elements 212 can be light emitting diodes (LEDs), and can be arranged in the one-dimensional direction. The connecting mechanism includes a plurality of connecting elements 214 for electrically connecting the first light bar 210 to the last light bar 210 in order. The front end 213 of the connecting mechanism is electrically connected to an external circuit board (not shown) and an external power supply device (not shown). The rear end 215 of the connecting mechanism is electrically connected to the closed-loop terminal 220, whereby the light bars 210 of the light bar set, the connecting elements 214 of the connecting mechanism and the closed-loop terminal 220 are formed to a closed loop so as to energize the LEDs. More detailed, the light bar set can include N light bars 210, N is an integer being more than one. The connecting mechanism can include N+1 connecting elements 214 for electrically connecting the first one to the N-th one of the light bars 210 and the closed-loop terminal 220 in order.

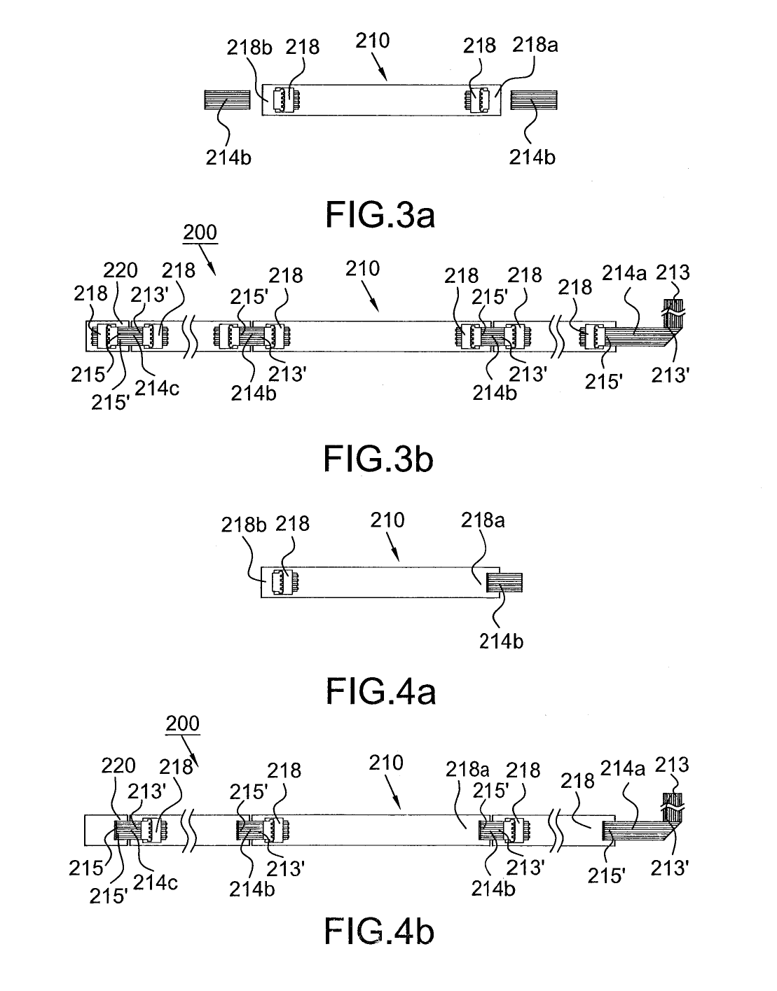

Referring to FIGS. 3a and 3b, they depict a light emitting unit 200 according to an example of the first embodiment of the present invention showing a normalized light bar 210 before assembly and a light emitting unit 200 after assembly. According to the normalized light bar 210, each light bar 210 includes a front connector 218 and a rear connector 218 disposed at the front end 218a and the rear end 218b respectively. The connecting elements 214 of the connecting mechanism are flexible circuit boards 214a, 214b, 214c, the flexible circuit board 214a, 214b, 214c has a front end 213′ and a rear end 215′, wherein the front end 213′ of the first flexible circuit board 214a is the front end 213 of the connecting mechanism, the rear end 215′ of the first flexible circuit board 214a is electrically connected with the front connector 218 of the first light bar 210; the front end 213′ of the second flexible circuit board 214b is electrically connected with the rear connector 218 of the first light bar 210, and the rear end 215′ of the second flexible circuit board 214b is electrically connected with the front connector 218 of the second light bar 210; likewise, the front end 213′ of the N-th flexible circuit board 214b is electrically connected with the rear connector 218 of the N−1-th light bar 210, and the rear end 215′ of the N-th flexible circuit board 214b is electrically connected with the front connector 218 of the N-th light bar 210; and the front end 213′ of the N+1-th flexible circuit board 214c is electrically connected with the rear connector 218 of the N-th light bar 210, and the rear end 215′ of the N+1-th flexible circuit board 214c is the rear end 215 of the connecting mechanism. The closed-loop terminal 220 can also include a connector 218, whereby the rear end 215′ of the N+1-th flexible circuit board 214c is electrically connected with the connector 218 of the closed-loop terminal 220. The normalized light bar 210 has a normalized structure being characterized in that a connector 218 is disposed at the rear end 218b of the light bar 210 and another connector 218 is disposed at the front end 218a of the light bar 210.

Referring to FIGS. 4a and 4b, they depict a light emitting unit 200 according to an alternative example of the first embodiment of the present invention showing a normalized light bar 210 before assembly and a light emitting unit 200 after assembly. According to the normalized light bar 210, each light bar 210 has a front end 218a and a rear end 218b, and includes a rear connector 218 disposed at the rear end 218b of the light bar 210 and a flexible circuit boards 214b electrically soldered to the front end 218a of the light bar 210. The connecting elements 214 of the connecting mechanism are flexible circuit boards 214a, 214b, 214c. The front end 213′ of the first flexible circuit board 214a is the front end 213 of the connecting mechanism, the rear end 215′ of the first flexible circuit board 214a is electrically soldered to the front end 218a of the first light bar 210; the front end 213′ of the second flexible circuit board 214b is electrically connected with the rear connector 218 of the first light bar 210, and the rear end 215′ of the second flexible circuit board 214b is electrically soldered to the front end 218a of the second light bar 210; likewise, the front end 213′ of the N-th flexible circuit board 214b is electrically connected with the rear connector 218 of the N−1-th light bar 210, and the rear end 215′ of the N-th flexible circuit board 214b is electrically soldered to the front end 218a of the N-th light bar 210; and the front end 213′ of the N+1-th flexible circuit board 214c is electrically connected with the rear connector 218 of the N-th light bar 210, and the rear end 215′ of the N+1-th flexible circuit board 214c is the rear end 215 of the connecting mechanism. The rear end 215′ of the N+1-th flexible circuit board 214c can be also electrically soldered to the closed-loop terminal. The normalized light bar 210 has a normalized structure being characterized in that a connector 218 is disposed at the rear end 218b of the light bar 210 and a flexible circuit board 214b is electrically soldered to the front end 218a of the light bar 210.

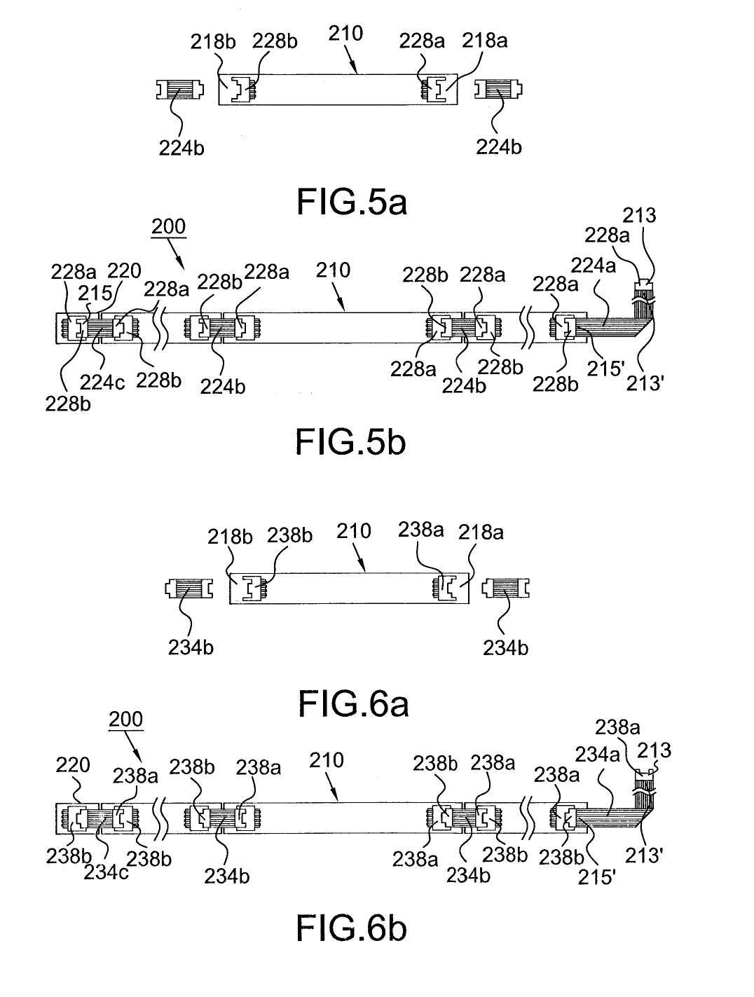

Referring to FIGS. 5a and 5b, they depict a light emitting unit 200 according to another example of the first embodiment of the present invention showing a normalized light bar 210 before assembly and a light emitting unit 200 after assembly. According to the normalized light bar 210, each light bar 210 includes a front plug 228a and a rear socket 228b disposed at the front end 218a and the rear end 218b respectively. The connecting elements 214 of the connecting mechanism are flexible flat cables 224a, 224b, 224c, the flexible flat cable 224a, 224b, 224c has a front plug 228a and a rear socket 228b disposed at the front end 213′ and the rear end 215′ of the flexible flat cables 224a, 224b, 224c respectively, the front plug 228a of the first flexible flat cable 224a is the front end 213 of the connecting mechanism, the rear socket 228b of the first flexible flat cable 224a is electrically connected with the front plug 228a of the first light bar 210; the front plug 228a of the second flexible flat cable 224b is electrically connected with the rear socket 228b of the first light bar 210, and the rear socket 228b of the second flexible flat cable 224b is electrically connected with the front plug 228a of the second light bar 210; likewise, the front plug 228a of the N-th flexible flat cable 224b is electrically connected with the rear socket 228b of the N−1-th light bar 210, and the rear socket 228b of the N-th flexible flat cable 224b is electrically connected with the front plug 228a of the N-th light bar 210; and the front plug 228a of the N+1-th flexible flat cable 224c is electrically connected with the rear socket 228b of the N-th light bar 210, and the rear socket 228b of the N+1-th flexible flat cable 224c is the rear end 215 of the connecting mechanism. The closed-loop terminal 220 can also include a plug 228a, whereby the plug 228a of the closed-loop terminal 220 is electrically connected with the rear socket 228b of the N+1-th flexible circuit board 224c. The normalized light bar 210 has a normalized structure being characterized in that a socket 228b is disposed at the rear end 218b of the light bar 210 and a plug 228a is disposed at the front end 218a of the light bar 210.

Referring to FIGS. 6a and 6b, they depict a light emitting unit 200 according to another alternative example of the first embodiment of the present invention showing a normalized light bar 210 before assembly and a light emitting unit 200 after assembly. According to the normalized light bar 210, each light bar 210 includes a front socket 238a and a rear plug 238b disposed at the front end 218a and the rear end 218b respectively. The connecting elements 234 of the connecting mechanism are flexible flat cables 234a, 234b, 234c. The flexible flat cable 234a, 234b, 234c includes a front socket 238a and a rear plug 238b disposed at the front end 213′ and the rear end 215′ of the flexible flat cable 234a, 234b, 234c respectively, the front socket 238a of the first flexible flat cable 234a is the front end 213 of the connecting mechanism, and the rear plug 238b of the first flexible flat cable 234a is electrically connected with the front socket 238a of the first light bar 210; the front socket 238a of the second flexible flat cable 234b are electrically connected with the rear plug 238b of the first light bar 210, and the front socket 238a of the second flexible flat cable 234b are electrically connected with the rear plug 238b of the second light bar 210; likewise, the front socket 238a of the N-th flexible flat cable 234b are electrically connected with the rear plug 238b of the N−1-th light bar 210, and the front socket 238a of the N-th flexible flat cable 234b are electrically connected with the rear plug 238b of the N-th light bar 210; and the front socket 238a of the N+1-th flexible flat cable 234c is electrically connected with the rear plug 238b of the N-th light bar 210, and the rear plug 238b of the N+1-th flexible flat cable 234c is the rear end 215 of the connecting mechanism. The closed-loop terminal 220 can also include a socket 238a, whereby the rear plug 238b of the N+1-th flexible circuit board 234c is electrically connected with the socket 238a of the closed-loop terminal 220. The normalized light bar 210 has a normalized structure being characterized in that a plug 238b is disposed at the rear end 218b of the light bar 210 and a socket 238a is disposed at the front end 218a of the light bar 210.

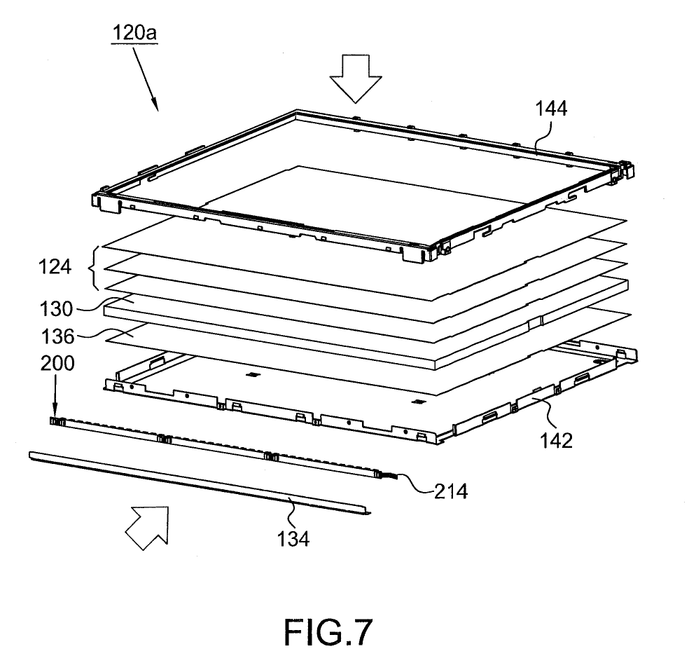

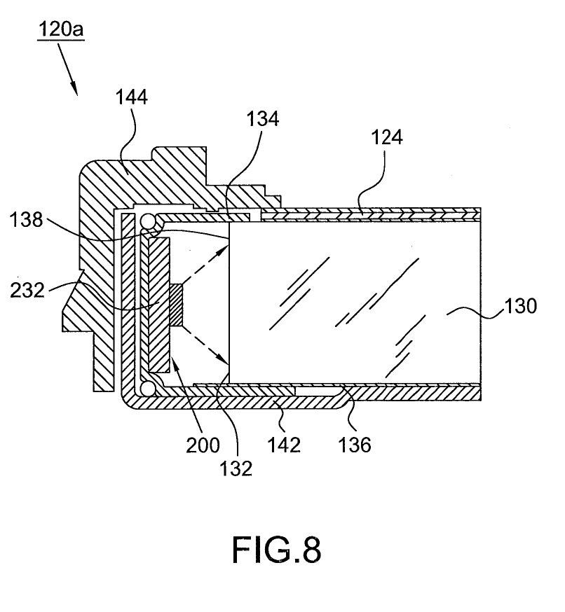

Referring to FIG. 7, it depicts a side light type backlight module 120a according to the first embodiment of the present invention, i.e. the light emitting unit 200 can be applied to the side light type backlight module 120a. The side light type backlight module 120a includes a light guide plate 130, the light emitting unit 200 of the present invention, a reflector 134 (e.g. U-shaped reflector), a reflecting plate 136 and a plurality of optical films 124. Referring to FIG. 8, the light emitting unit 200 is disposed on at least one side surface 132 of the light guide plate 130. The reflector 134 surrounds the light emitting unit 200, and an opening 138 of the reflector 134 faces the side surface 132 of the light guide plate 130 for reflecting lights of the light emitting unit 200 to the light guide plate 130. The reflecting plate 136 is mounted on a bottom surface of the light guide plate 130. The optical films 124 (e.g. a diffusing sheet and a prism sheet) are disposed on a top surface of the light guide plate 130. The backlight module 120a further includes a housing 142 and a frame 144, wherein the housing 142 is assembled with the frame 144, whereby the light guide plate 130, the light emitting unit 200, the reflector 134 and the optical films 124 are mounted between the housing 142 and the frame 144.

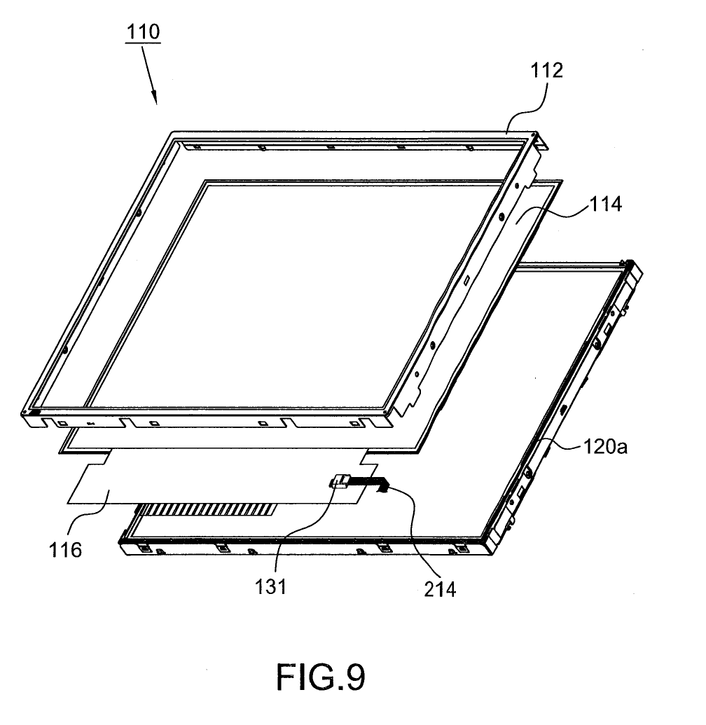

Referring to FIG. 9, it depicts a display device according to the first embodiment of the present invention, i.e. the backlight module 120a can be applied to the display device, e.g. liquid crystal display device 110. The liquid crystal display device 110 includes a front frame 112, a display panel (liquid crystal display panel 114) and the backlight module 120a of the present invention. The liquid crystal display panel 114 has a liquid crystal layer (not shown) disposed between upper and lower substrates (not shown) for displaying images. The liquid crystal display panel 114 includes a printed circuit board 116 and a connector 131 disposed on the printed circuit board 116. The printed circuit board 116 is adapted to transmit control and driving signals to the liquid crystal display panel 114. The front end of the connecting element 214 of the connecting mechanism of the light emitting unit 200 of the backlight module 120a is electrically connected to the printed circuit board 116 by a connector 131. In addition, in another embodiment the connecting element 214 can be electrically soldered to the printed circuit board 116 rather than electrically connected to the printed circuit board by a connector. The backlight module 120a provides the liquid crystal display panel 114 with a uniform backlight. The backlight module 120a is assembled with the front frame 112 for combining the front frame 112, the liquid crystal display panel 114 and the backlight module 120a to a liquid crystal display device 110.

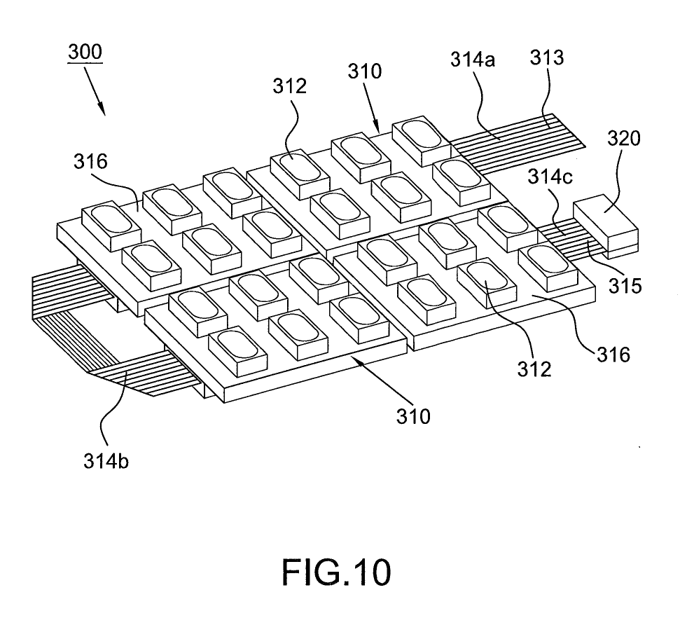

Referring to FIG. 10, it depicts a light emitting unit 300 according to the second embodiment of the present invention. The light emitting unit 300 in the second embodiment is similar to the light emitting unit 200 in the first embodiment, wherein the similar elements are designated with the similar reference numerals. The light emitting unit 300 includes a light bar set, a connecting mechanism and a closed-loop terminal 320. The light bar set includes a plurality of normalized light bars 310. The light bars 310 are arranged in the two-dimensional direction. Each light bar 310 includes a plurality of light emitting elements 312 and a circuit board 316, and the light emitting elements 312 are disposed on the circuit board 316. The light emitting elements 312 can be light emitting diodes (LEDs). In this embodiment, the light emitting elements 312 can be arranged in the two-dimensional direction. In another embodiment, the light emitting elements 312 can be arranged in the one-dimensional direction (not shown). The connecting mechanism includes a plurality of connecting elements 314a, 314b, 314c for electrically connecting from the first one to the last one of the light bars 310 in order. The front end 313 of the connecting mechanism is electrically connected to an external circuit board (not shown) and an external power supply device (not shown). The rear end 315 of the connecting mechanism is electrically connected to the closed-loop terminal 320, whereby the light bars 310 of the light bar set, the connecting elements 314 of the connecting mechanism and the closed-loop terminal 320 are formed to a closed loop. More detailed, the light bar set can include N light bars 310, N is an integer being more than one. The connecting mechanism can include N+1 connecting elements 314 for electrically connecting the first one to the N-th one of the light bars 310 and the closed-loop terminal 320 in order.

Similar to four examples of the first embodiment, the normalized light bar in the second embodiment has a normalized structure being characterized in that a connector is disposed at the rear end of the light bar and another connector is disposed at the front end of the light bar. Or, the normalized light bar in the second embodiment has a normalized structure being characterized in that a connector is disposed at the rear end of the light bar and a flexible circuit board is electrically soldered to the front end of the light bar. Or, the normalized light bar in the second embodiment has a normalized structure being characterized in that a socket is disposed at the rear end of the light bar and a plug is disposed at the front end of the light bar. Or, the normalized light bar in the second embodiment has a normalized structure being characterized in that a plug is disposed at the rear end of the light bar and a socket is disposed at the front end of the light bar.

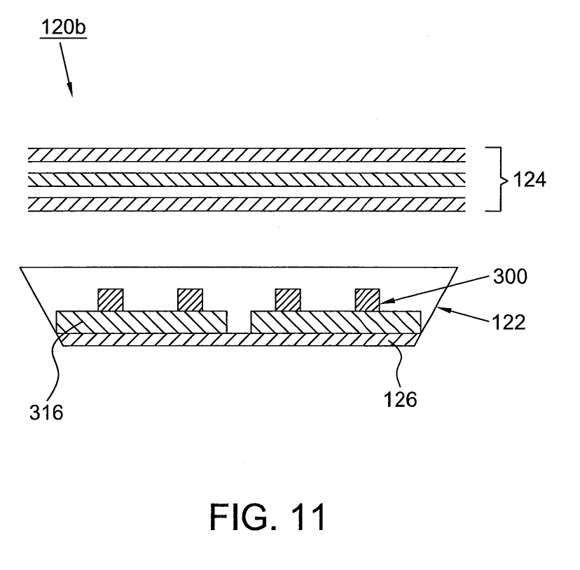

Referring to FIG. 11, it depicts a direct light type backlight module 120b according to the second embodiment of the present invention, i.e. the light emitting unit 300 can be applied to the direct light type backlight module 120b. The direct light type backlight module 120b includes a housing 122, the light emitting unit 300 of the present invention, and a plurality of optical films 124. The housing 122 has a bottom plate 126 for support the light emitting unit 300 and disposing the light emitting unit 300 in the housing 122. The optical films 124 (e.g. a diffusing sheet and a prism sheet) are disposed above the housing 122.

The backlight module 120b can be also applied to the display device, e.g. liquid crystal display device. The liquid crystal display device includes a front frame, a display panel (liquid crystal display panel) and the backlight module 120b of the present invention. The liquid crystal display panel includes a printed circuit board and a connector disposed on the printed circuit board. The front end of the connecting element of the connecting mechanism of the light emitting unit of the backlight module 120b is electrically connected to the printed circuit board by a connector. In addition, in another embodiment the connecting element can be electrically soldered to the printed circuit board rather than electrically connected to the printed circuit board by a connector. The backlight module 120b provides the liquid crystal display panel with a uniform backlight. The backlight module 120b is assembled with the front frame for combining the front frame, the liquid crystal display panel and the backlight module 120b to a liquid crystal display device.

According to the light emitting unit of the backlight module of the large-size liquid crystal display device, the present invention provide a light emitting unit which is assembled with enough normalized light bars in number in accordance with design requirement, and thus the light emitting unit of the present invention has no problem of a longer circuit board of the conventional light emitting unit (having the single integral body). Furthermore, the number of the LEDs of the single normalized light bar of the present invention is not more, but enough LEDs in number are shared by a plurality of normalized light bars. Therefore, if a normalized light bar is failed, only the failed normalized light bar is replaced rather than the whole light emitting unit is replaced so as to save material cost. In addition, normalized light bars of the light emitting unit of the present invention are easily manufactured and stocked so as to have lower product cost.

Although the invention has been explained in relation to its preferred embodiment, it is not used to limit the invention. It is to be understood that m any other possible modifications and variations can be made by those skilled in the art without departing from the spirit and scope of the invention as hereinafter claimed.

What is claimed is:

1. A light emitting unit comprising:
a light bar set comprising a plurality of light bars, wherein each light bar comprises a plurality of light emitting elements and a circuit board, and the light emitting elements are disposed on the circuit board;
a connecting mechanism comprising a plurality of connecting elements for electrically connecting the first one to the last one of the light bars in order, wherein the connecting mechanism has a front end and a rear end; and
a closed-loop terminal electrically connected to the rear end of the connecting mechanism, whereby the light bar set, the connecting mechanism and the closed-loop terminal are formed to a closed loop.

2. The light emitting unit as claimed in claim 1, wherein:
the light bar set comprises N light bars, N is an integer being more than one; and
the connecting mechanism comprise N+1 connecting elements for electrically connecting the first one to the N-th one of the light bars and the closed-loop terminal in order.

3. The light emitting unit as claimed in claim 2, wherein:
each light bar has a front end and a rear end, and includes a front connector and a rear connector disposed at the front end and the rear end respectively; and
the connecting elements is a flexible circuit board, the flexible circuit board has a front end and a rear end, the front end of the first flexible circuit board is the front end of the connecting mechanism, the rear end of the first flexible circuit board is electrically connected with the front connector of the first light bar, the front end and rear end of the N-th flexible circuit board are electrically connected with the rear connector of the N−1-th light bar and the front connector of the N-th light bar respectively, the front end of the N+1-th flexible circuit board is electrically connected with the rear connector of the N-th light bar, and the rear end of the N+1-th flexible circuit board is the rear end of the connecting mechanism.

4. The light emitting unit as claimed in claim 2, wherein:
each light bar has a front end and a rear end, and includes a rear connector disposed at the rear end; and
the connecting elements is a flexible circuit board, the flexible circuit board has a front end and a rear end, the front end of the first flexible circuit board is the front end of the connecting mechanism, the rear end of the first flexible circuit board is electrically soldered to the front connector of the first light bar, the front end of the N-th flexible circuit board is electrically connected with the rear connector of the N−1-th light bar, the rear end of the N-th flexible circuit board is electrically soldered to the front connector of the N-th light bar, the front end of the N+1-th flexible circuit board is electrically connected with the rear connector of the N-th light bar, and the rear end of the N+1-th flexible circuit board is the rear end of the connecting mechanism.

5. The light emitting unit as claimed in claim 2, wherein:
each light bar has a front end and a rear end, and includes a front plug and a rear socket disposed at the front end and the rear end respectively; and
the connecting elements are flexible flat cables, the flexible flat cable has a front end and a rear end, the flexible flat cable includes a front plug and a rear socket disposed at the front end and the rear end respectively, the front plug of the first flexible flat cable is the front end of the connecting mechanism, the rear socket of the first flexible flat cable is electrically connected with the front plug of the first light bar, the front plug and rear socket of the N-th flexible flat cable are electrically connected with the rear socket of the N−1-th light bar and the front plug of the N-th light bar respectively, the front plug of the N+1-th flexible flat cable is electrically connected with the rear socket of the N-th light bar, and the rear socket of the N+1-th flexible flat cable is the rear end of the connecting mechanism.

6. The light emitting unit as claimed in claim 2, wherein:
each light bar has a front end and a rear end, and includes a front socket and a rear plug disposed at the front end and the rear end respectively; and
the connecting elements are flexible flat cables, the flexible flat cable has a front end and a rear end, the flexible flat cable includes a front socket and a rear plug disposed at the front end and the rear end respectively, the front socket of the first flexible flat cable is the front end of the connecting mechanism, the rear plug of the first flexible flat cable is electrically connected with the front socket of the first light bar, the front socket and rear plug of the N-th flexible flat cable are electrically connected with the rear plug of the N−1-th light bar and the front socket of the N-th light bar respectively, the front socket of the N+1-th flexible flat cable is electrically connected with the rear plug of the N-th light bar, and the rear plug of the N+1-th flexible flat cable is the rear end of the connecting mechanism.

7. The light emitting unit as claimed in claim 1, wherein the front end of the connecting mechanism is electrically connected to one of an external circuit board and an external power supply device.

8. The light emitting unit as claimed in claim 1, wherein the light emitting element is a light emitting diode.

9. A backlight module comprising:
a light guide plate having a side surface;
a light emitting unit disposed on the side surface of the backlight module and comprising:
a light bar set comprising a plurality of light bars, wherein each light bar comprises a plurality of light emitting elements and a circuit board, and the light emitting elements are disposed on the circuit board;
a connecting mechanism comprising a plurality of connecting elements for electrically connecting the first one to the last one of the light bars in order, wherein the connecting mechanism has a front end and a rear end; and
a closed-loop terminal electrically connected to the rear end of the connecting mechanism, whereby the light bar set, the connecting mechanism and the closed-loop terminal are formed to a closed loop; and
a reflector surrounding the light emitting unit and comprising an opening which faces the side surface of the light guide plate for reflecting lights of the light emitting unit to the light guide plate.

10. The backlight module as claimed in claim 9, further comprising a housing and a frame assembled with the housing, whereby the light guide plate, the light emitting unit and the reflector are mounted between the housing and the frame.

11. The backlight module as claimed in claim 9, wherein the light emitting elements are light emitting diodes, and are arranged in the one-dimensional direction.

12. The backlight module as claimed in claim 9, wherein the light bars are arranged in the one-dimensional direction.

13. A backlight module comprising:
a light emitting unit comprising:
a light bar set comprising a plurality of light bars, wherein each light bar comprises a plurality of light emitting elements and a circuit board, and the light emitting elements are disposed on the circuit board;
a connecting mechanism comprising a plurality of connecting elements for electrically connecting the first one to the last one of the light bars in order, wherein the connecting mechanism has a front end and a rear end; and
a closed-loop terminal electrically connected to the rear end of the connecting mechanism, whereby the light bar set, the connecting mechanism and the closed-loop terminal are formed to a closed loop; and
a housing for supporting the light emitting unit, whereby the light emitting unit is disposed in the housing.

14. The backlight module as claimed in claim 13, wherein the light emitting elements are light emitting diodes, and are arranged in the two-dimensional direction.

15. The backlight module as claimed in claim 13, wherein the light emitting elements are light emitting diodes, and are arranged in the one-dimensional direction.

16. The backlight module as claimed in claim 14, wherein the light bars are arranged in the two-dimensional direction.

17. A display device comprising:
a display panel comprising a printed circuit board; and
a backlight module comprising a light emitting unit, and the light emitting unit comprises:
a light bar set comprising a plurality of light bars, wherein each light bar comprises a plurality of light emitting elements and a circuit board, and the light emitting elements are disposed on the circuit board;
a connecting mechanism comprising a plurality of connecting elements for electrically connecting the first one to the last one of the light bars in order, wherein the connecting mechanism has a front end and a rear end; and
a closed-loop terminal electrically connected to the rear end of the connecting mechanism, whereby the light bar set, the connecting mechanism and the closed-loop terminal are formed to a closed loop; and
a housing for supporting the light emitting unit, whereby the light emitting unit is disposed in the housing.

18. The display device as claimed in claim 17, further comprising a front frame, wherein the backlight module is assembled with the front frame for combining the front frame, the display panel and the backlight module to a display device.

19. The display device as claimed in claim 17, wherein the display panel comprises a connector disposed on the printed circuit board for electrically connecting the front end of the connecting mechanism to the printed circuit board of the display panel.

20. The display device as claimed in claim 17, wherein the front end of the connecting mechanism is electrically soldered to the printed circuit board of the display panel.
